(19) United States
(12) Patent Application Publication
(10) Pub. No.: US 2025/0075552 A1
(43) Pub. Date: Mar. 6, 2025

(54) OPENING AND CLOSING CONTROL DEVICE

(71) Applicant: ALPS ALPINE CO., LTD., Tokyo (JP)

(72) Inventors: Shinichi ENDO, Tokyo (JP); Kenji MASUZAWA, Miyagi (JP); Kazuhiro HAMAMATSU, Miyagi (JP)

(21) Appl. No.: 18/817,549

(22) Filed: Aug. 28, 2024

(30) Foreign Application Priority Data
Sep. 5, 2023 (JP) 2023-143857

(51) Int. Cl. E05F 15/40; E05F 15/695; E05F 15/697

(52) U.S. Cl. CPC E05F 15/40; E05F 15/695; E05F 15/697; E05Y 2400/32; E05Y 2900/55

(57) ABSTRACT

An opening and closing control device configured to control an opening and closing operation of an opening and closing body by a motor, includes processing circuitry configured to measure a current value of a current flowing through the motor, detect a ripple of the current, calculate a load in the opening and closing operation of the opening and closing body based on the current value of the current, calculate a position of the opening and closing body based on the ripple of the current, and determine that an object is pinched by the opening and closing body based on the position of the opening and closing body and the load, wherein the processing circuitry is configured to calculate the position of the opening and closing body based on a current value of the current measured in response to the detection of the ripple of the current.

### BACKGROUND OF THE INVENTION

### 1. Field of the Invention

The present disclosure relates to an opening and closing control device.

### 2. Description of the Related Art

Conventionally, there has been an opening and closing control device to control an opening and closing operation of an opening and closing body driven by a motor. The opening and closing control device includes a current detection unit to detect a current flowing through the motor, an angular velocity detection unit to detect an angular velocity of rotation of the motor, a load calculation unit to calculate a load in the opening and closing operation of the opening and closing body based on the current detected by the current detection unit and the angular velocity detected by the angular velocity detection unit, a pinch detection unit to detect an object being pinched by the opening and closing body based on the load calculated by the load calculation unit, and a motor control unit to perform a pinch prevention control by reversing the rotation of the motor when the pinch is detected by the pinch detection unit. The load calculation unit calculates the load acquired combining a first load component proportional to the detected current and a second load component proportional to the angular acceleration of rotation of the motor approximated based on the detected angular velocity. The angular velocity detection unit extracts a ripple of the detected current generated every time the motor rotates by a predetermined angle, and calculates the detected angular velocity based on an interval at which the ripple occurs (for example, see Patent Literature (PTL) 1).

A related opening and closing control device detects a pinch by calculating a load based on a detected current and a detected angular velocity, but when timing to measure a ripple of the current is not considered, the load calculation accuracy is lowered due to an effect of a fluctuation of the ripple. When calculation accuracy of the load is lowered, detection accuracy of the pinch is lowered.

Therefore, an object of the present embodiments is to provide the opening and closing control device capable of highly accurately detecting the pinch of the object by an opening and closing body whose opening and closing operation is performed by a motor.

### CITATION LIST

### Patent Literature

[PTL 1] Japanese Laid-Open Patent Publication No. 2018-003426

### SUMMARY OF THE INVENTION

An opening and closing control device configured to control an opening and closing operation of an opening and closing body by a motor, includes processing circuitry configured to measure a current value of a current flowing through the motor, detect a ripple of the current, calculate a load in the opening and closing operation of the opening and closing body based on the current value of the current, calculate a position of the opening and closing body based on the ripple of the current, and determine that an object is pinched by the opening and closing body based on the position of the opening and closing body and the load, wherein the processing circuitry is configured to calculate the position of the opening and closing body based on a current value of the current measured in response to the detection of the ripple of the current.

It is possible to provide an opening and closing control device capable of detecting pinch of an object by an opening and closing body which is opened and closed by a motor with high accuracy.

### BRIEF DESCRIPTION OF THE DRAWINGS

FIG. 1 is a drawing illustrating one example of a configuration of an opening and closing control device according to the present embodiment;

FIG. 2 is a drawing illustrating an overview of an operation of the opening and closing control device at each stage after the motor is started;

FIG. 3 is a flowchart to describe the pinch prevention function of the opening and closing control device;

FIG. 4A is a drawing describing a problem in a case of using a current average value that does not consider timing at which a ripple is detected in the opening and closing control device for comparison;

FIG. 4B is a drawing describing one example of solution 1;

FIG. 4C is a drawing describing one example of an effect of solution 1;

FIG. 4D is a drawing describing one example of solution 2;

FIG. 4E is a drawing describing one example of solution 3;

FIG. 4F is a drawing illustrating one example of an effect of solution 4;

FIG. 5A is a flowchart illustrating one example of the detected current acquisition process according to solution 1;

FIG. 5B is a flowchart illustrating one example of the detected current acquisition process according to solution 2;

FIG. 5C is a flowchart illustrating one example of the detected current acquisition process according to a variation of solution 2;

FIG. 5D is a flowchart illustrating one example of the detected current acquisition process according to solution 3;

FIG. 5E is a flowchart illustrating one example of the detected current acquisition process according to solution 4;

FIG. 6 is a flowchart illustrating a calculation of a reference value;

FIG. 7 is a flowchart to describe a weighted average process in the calculation of the reference value;

FIG. 8A illustrates an example in which a reference value is calculated by the weighted average process;

FIG. 8B illustrates an example in which an update of the reference value is stopped due to a sudden rise in the calculated load;

FIG. 9 is a first flowchart to describe a configuration of a pinch threshold;

FIG. 10 is a second flowchart to describe the configuration of the pinch threshold;

FIG. 11 is a drawing illustrating an example of the configuration of the pinch threshold in a proximate range of a fully closed position;

FIG. 12 is a first flowchart to describe a pinch determination;

FIG. 13 is a second flowchart to describe the pinch determination; and

FIG. 14 is a drawing to describe conditions for monotonical increase of the calculated load in the pinch determination.

### DESCRIPTION OF THE PREFERRED EMBODIMENTS

In the following, embodiments to which the opening and closing control device of the present invention is applied are described.

### Embodiment 1

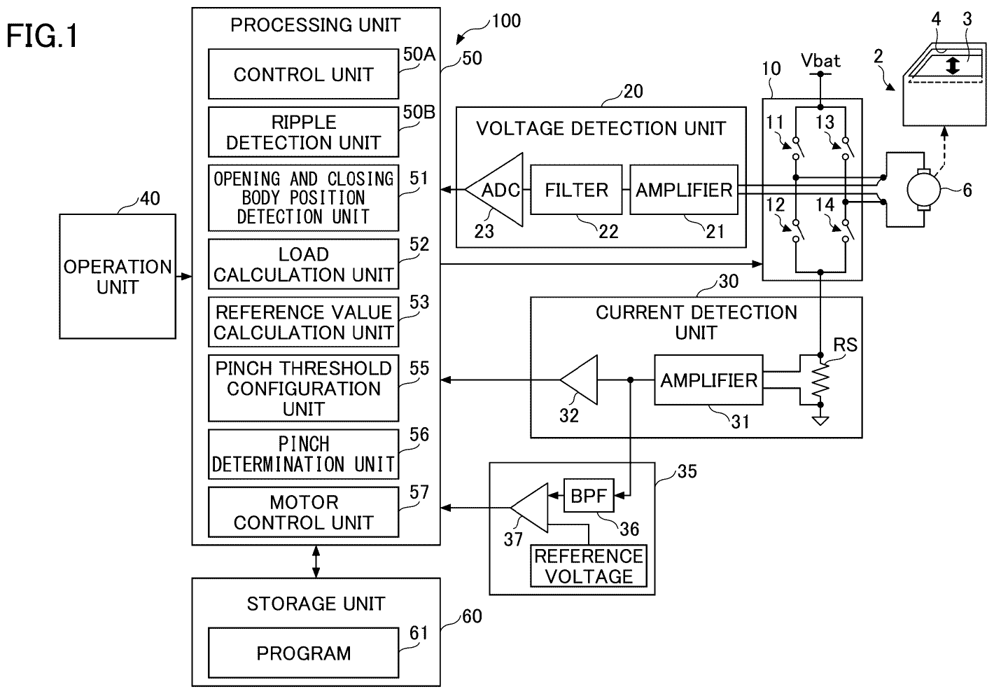

FIG. 1 is a drawing illustrating one example of a configuration of an opening and closing control device 100 according to the present embodiment. The opening and closing control device 100 according to the present embodiment is a device to control an opening and closing operation of an opening and closing body 3 (window) driven by a motor 6, and in the example of FIG. 1, controls the opening and closing operation of the opening and closing body 3 (window) attached to a window frame 4 of a door 2 in a vehicle. The opening and closing control device 100 shown in FIG. 1 includes a motor drive circuit 10, a voltage detection unit 20, a current detection unit 30, a ripple detection unit 35, an operation unit 40, a processing unit 50, and a storage unit 60. The current detection unit 30 is one example of a current measuring unit.

The motor drive circuit 10 generates a voltage for driving the motor 6 in response to a control signal generated by the motor control unit 57 (described later) of the processing unit 50. In the example of FIG. 1, the motor drive circuit 10 has four switch elements (11-14) constituting a full bridge circuit. The switch elements 11 and 12 are connected in series between a power supply voltage Vbat of a battery or the like and ground, and the connection midpoint thereof is connected to one input terminal of the motor 6. The switch elements 13 and 14 are connected in series between a power supply voltage Vbat and ground, and the connection midpoint thereof is connected to the other input terminal of the motor 6. The motor 6 is, for example, a DC motor, and a direction of rotation is reversed according to a polarity of voltages applied to the two input terminals.

The voltage detection unit 20 detects a voltage supplied to the motor 6. In the example of FIG. 1, the voltage detection unit 20 includes an amplifier 21, a filter 22, and an ADC (analog to digital converter) 23. The amplifier 21 amplifies the voltage applied to the two input terminals of the motor 6 with a predetermined gain. The filter 22 removes the switching frequency component from the output signal of the amplifier 21 and outputs a signal corresponding to the average voltage supplied to the motor 6 to the ADC 23. The ADC 23 digitally converts the input signal and outputs it. The voltage detection unit 20 outputs a digital signal corresponding to the voltage supplied to the motor 6 to the processing unit 50.

The current detection unit 30 detects (measures) a current flowing through the motor 6. In the example of FIG. 1, the current detection unit 30 includes a shunt resistor RS, an amplifier 31, and an ADC (analog to digital converter) 32. The shunt resistor RS is provided in the current path between the full bridge circuit (11-14) of the motor drive circuit 10 and the ground, and generates a voltage corresponding to the current flowing through the motor 6. The amplifier 31 amplifies the voltage generated in the shunt resistor RS with a predetermined gain. The ADC 32 is connected between the output terminal of the amplifier 31 and the processing unit 50. The ADC 32 digitally converts the voltage output from the amplifier 31 and outputs it to the processing unit 50.

The ripple detection unit 35 has a BPF (band pass filter) 36 and a comparator 37, and detects a ripple by using the occurrence of a ripple in the current of the motor 6 every time the motor 6 rotates by a certain angle. The BPF 36 and the comparator 37 branch from between the output terminal of the amplifier 31 and the input terminal of the ADC 32 and are connected between the output terminal of the amplifier 31 and the processing unit 50. The BPF 36 has a pass band for passing a frequency component of the ripple of the voltage output from the amplifier 31, and outputs a signal of the passed voltage component to the comparator 37. The comparator 37 has one input terminal connected to the output terminal of the BPF 36, the other input terminal connected to a reference voltage (for example, 2.5 V), and the output terminal connected to the processing unit 50. The comparator 37 compares the signal input from the BPF 36 with the reference voltage, and outputs a ripple detection signal representing detection of the ripple to the processing unit 50.

A result of detection of the voltage of the motor 6 by the voltage detection unit 20 and a result of detection of the current of the motor 6 by the current detection unit 30 are used to calculate the load of the opening and closing operation of the opening and closing body 3 in the load calculation unit 52 described later. The voltage detection unit 20 and the current detection unit 30 are examples of sensors in the present embodiments.

The operation unit 40 is a device to input a signal for a user to operate the opening and closing operation of the opening and closing body 3 to the processing unit 50, and includes, for example, a switch.

The processing unit 50 controls the overall operation of the opening and closing control device 100. The processing unit 50 includes, for example, a computer having a processor that executes processes according to an instruction code of a program stored in the storage unit 60. The processing unit 50 may execute all the processes by the computer, or at least a part of the processes may be executed by a dedicated hardware circuit (random logic or the like).

The processing unit 50 includes an opening and closing body position detection unit 51, a load calculation unit 52, a reference value calculation unit 53, a pinch threshold configuration unit 55, a pinch determination unit 56, and a motor control unit 57. The opening and closing body position detection unit 51 is one example of a position calculation unit. The opening and closing body position detection unit 51, the load calculation unit 52, the reference value calculation unit 53, the pinch threshold configuration unit 55, the pinch determination unit 56, and the motor control unit 57 represent functions of the program executed by the processing unit 50 as functional blocks.

### [Opening and Closing Body Position Detection Unit 51]

The opening and closing body position detection unit 51 detects the position of the opening and closing body 3 in the opening and closing operation. For example, the opening and closing body position detection unit 51 counts the ripple detection signal input from the ripple detection unit 35 and detects the position of the opening and closing body 3 based on the count number. In this way, the opening and closing body position detection unit 51 acquires the ripple count value (count number) corresponding to the rotation amount of the motor 6 as information on the position of the opening and closing body 3.

### [Load Calculation Unit 52]

The load calculation unit 52 calculates the load F in the opening and closing operation of the opening and closing body 3 based on the current (hereinafter, may be referred to as “motor current Im”) detected by the current detection unit 30.

The load calculation unit 52 calculates the calculated load F each time a pulse is detected based on the motor current Im acquired each time a pulse is detected by the current detection unit 30 and the voltage detection unit 20. That is, the load calculation unit 52 performs a calculation process of the calculated load F every time a pulse is detected. “n” in the calculated load F(n) is an integer representing each processing cycle in the periodic calculation processes of the calculated load F. When the value of “n” increases by one, the order of the processing cycles advances by one (the time advances by a predetermined time Ts). Therefore, “n” can be regarded as a numerical value representing time in units of a predetermined time Ts. In the following description, “n” may be used as a numerical value representing time.

The first load component F1(n) is expressed by the following formula:

$$\begin{matrix}[ Formula 1 ] & \\ F 1 ( n ) = \frac{Kt}{L} \cdot Im ( n ) & ( 1 )\end{matrix}$$

In formula 1, “Kt” represents a motor torque constant [N·m/A], and “L” represents a movement amount [m/rad] of the opening and closing body 3 per unit rotation angle.

### [Reference Value Calculation Unit 53]

The reference value calculation unit 53 calculates a weighted average result of the calculated load F(n) calculated by the load calculation unit 52 as a reference value B(n). For example, each time the load calculation unit 52 calculates a new calculated load F(n), the reference value calculation unit 53 calculates a weighted average result of the new calculated load F(n) and the past (recent) reference value B(n−1) as a new reference value B(n). The weighted average is expressed by the following formula, where the weighting coefficient is “M”.

$$\begin{matrix}[ Formula 2 ] & \\ B ( n ) = \frac{( M - 1 ) \times B ( n - 1 ) + F ( n )}{M} & ( 2 )\end{matrix}$$

### [Pinch Threshold Configuration Unit 55]

The pinch threshold configuration unit 55 configures a pinch threshold Fth for determining the upper limit of the calculated load F(n). For example, the pinch threshold Fth determines the allowable range of the difference “F(n)−B(n)” (the excess amount of the calculated load F(n) with respect to the reference value B(n)) between the calculated load F(n) and the reference value B(n). In this case, the sum of the pinch threshold Fth and the reference value B(n) corresponds to the upper limit of the calculated load F(n).

The pinch threshold configuration unit 55 switches the value of the pinch threshold Fth between the initial duration after the motor 6 starts and the duration after the initial duration. That is, the pinch threshold configuration unit 55 configures the start-up threshold Fth1 in the initial duration, and configures the steady-state threshold Fth2 in the duration after the initial duration. The start-up threshold Fth1 has a larger value than the steady-state threshold Fth2 in order to avoid erroneously determining a large fluctuation of the calculated load F(n) in the initial duration as a pinch.

Further, the pinch threshold configuration unit 55 temporarily increases the pinch threshold Fth when the reduction amount “F(n−p4)−F(n)” of the calculated load F per predetermined time p4 exceeds the initial reduction amount threshold ΔFp4 in the initial duration after the motor 6 starts.

### [Pinch Determination Unit 56]

When the calculated load F(n) exceeds the upper limit configured by the pinch threshold Fth, the pinch determination unit 56 determines that the object is pinched by the opening and closing body 3. For example, when the difference “F(n)−B(n)” between the calculated load F(n) and the reference value B(n) is larger than the pinch threshold Fth, the pinch determination unit 56 determines that the object is pinched by the opening and closing body 3.

For example, whenever the new calculated load F(n) is calculated by the load calculation unit 52, the pinch determination unit 56 determines whether or not the pattern of change of the calculated load F corresponds to a predetermined pattern of monotonic increase based on a series of a plurality of calculated loads F including the new calculated load F(n). The pinch determination unit 56 determines that pinch has occurred when the first condition where the difference “F(n)−B(n)” between the calculated load F(n) and the reference value B(n) is larger than the pinch threshold Fth and the second condition where the pattern of change of the calculated load F corresponds to the pattern of monotonic increase are satisfied.

The pinch determination unit 56 determines that pinch has occurred when the increase amount “F(n)−F(n−q3)” of the calculated load F per predetermined time q3 is larger than the threshold ΔFh indicating the occurrence criterion of the pinch of a hard object is satisfied in addition to the first and second conditions described above and the third condition where the change of the calculated load F is accelerated.

### [Motor Control Unit 57]

The motor control unit 57 generates a control signal for the motor 6 corresponding to an operation signal input by the operation unit 40, and outputs it to the motor drive circuit 10. The motor control unit 57 generates a control signal to be output to the motor drive circuit 10 so as to satisfy the predetermined conditions such as the rotational direction and rotational speed of the motor 6 for each of the closing and opening operations.

When the pinch determination unit 56 determines that an object is pinched, the motor control unit 57 performs pinch prevention control to reverse the rotation of the motor 6. For example, when the pinch determination unit 56 determines that an object is pinched during the closing operation, the motor control unit 57 performs the opening operation by reversing the motor 6, and stops the opening and closing body 3 at an appropriate position. This is the description of the processing unit 50.

The storage unit 60 stores a computer program 61 in the processing unit 50, constant data used for the process of the processing unit 50, variable data temporarily held in the process of the processing unit 50, and the like. The storage unit 60 includes, for example, storage devices such as a DRAM, an SRAM, a flash memory, and a hard disk.

The program 61 may be stored in the storage unit 60 in advance, a program downloaded from another server or the like via an interface device not shown may be stored in the storage unit 60, or a program read from a non-temporary tangible medium (an optical disk, a USB memory, etc.) by a reader not shown may be stored in the storage unit 60.

Next, the operation of the opening and closing control device 100 according to the present embodiment having the above-described configuration will be described.

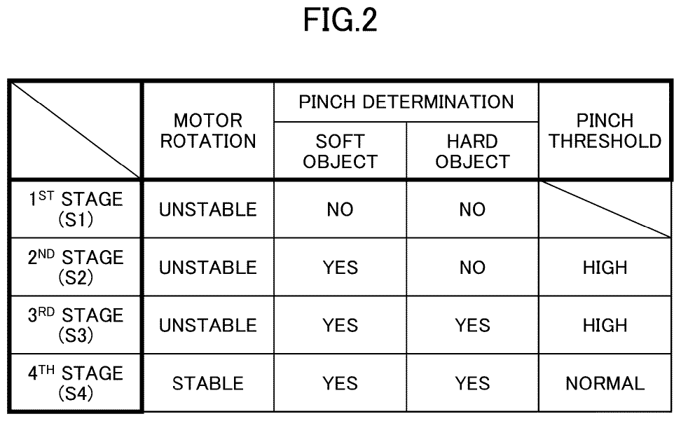

FIG. 2 is a drawing illustrating an overview of an operation of the opening and closing control device 100 at each stage after the motor is started. The opening and closing control device 100 according to the present embodiment executes different operations for each of the four stages (first stage S1 to fourth stage S4) corresponding to the rotational state of the motor 6. The first stage S1 to fourth stage S4 are durations divided according to the elapsed time from the starting time of the motor 6, and the elapsed time from the starting time becomes longer in this order. As shown in FIG. 2, the rotational state of the motor 6 is unstable in stages closer to the starting time, but is generally stable in stage S4.

As shown in FIG. 2, the opening and closing control device 100 determines whether the object is pinched in the second stage S2 and later, and does not determine whether the object is pinched in the first stage S1. Therefore, the opening and closing control device 100 does not configure the pinch threshold Fth (calculation of the increment value or the like) in the first stage S1.

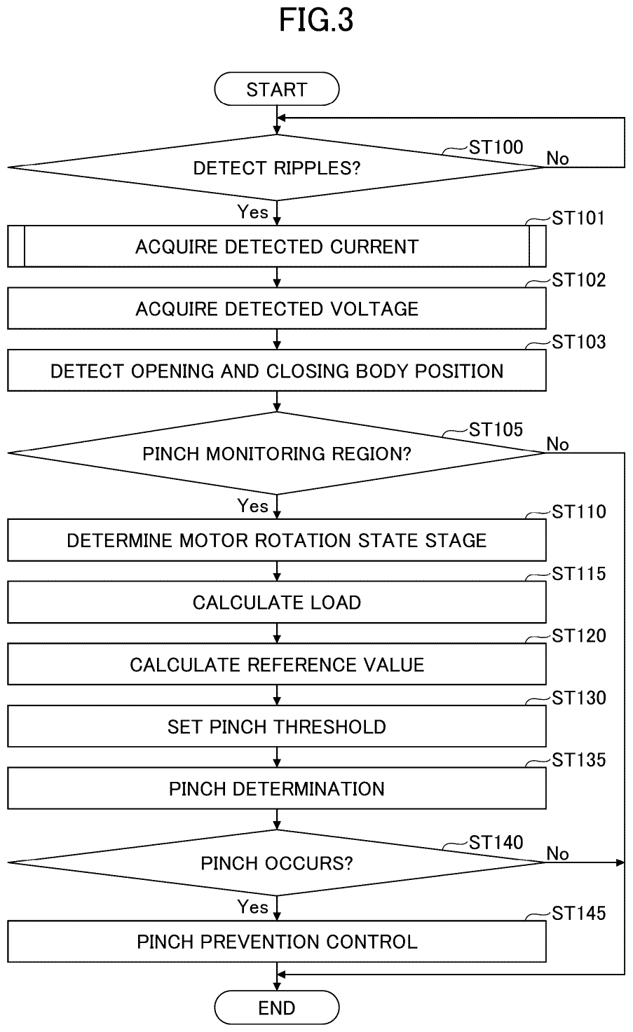

FIG. 3 is a flowchart to describe the pinch prevention function of the opening and closing control device 100. The process shown in FIG. 3 is repeatedly executed at every predetermined time Ts, for example.

### ST100:

The processing unit 50 determines whether the ripple detection unit 35 has detected a ripple. If the ripple detection unit 35 determines that no ripple is detected (ST100: No), the processing unit 50 repeats the process of step ST100. If the processing unit 50 determines that the ripple detection unit 35 has detected a ripple (ST100: Yes), the flow proceeds to step ST101.

### ST101:

The processing unit 50 acquires the detected current by the current detection unit 30. The processing in step ST101 is a subroutine process to acquire the detected current from the current detection unit 30. When the processing unit 50 acquires the detected current, the flow proceeds to step ST102. Details of step ST101 will be described later.

### ST102:

The processing unit 50 acquires the voltage detected by the voltage detection unit 20.

### ST103:

The opening and closing body position detection unit 51 detects the position of the opening and closing body 3 to be opened and closed based on the ripple component contained in the current of the motor 6.

### ST105:

In the processing unit 50, when the position of the opening and closing body 3 is in the pinch monitoring region where the pinch prevention control is to be performed, the processing unit 50 executes the process after step ST110. In the case where the position of the opening and closing body 3 is not in the pinch monitoring region (for example, in the proximity of the fully closed position, when the opening and closing body 3 is in a non-reversing region that does not reverse), the processing unit 50 skips the process after step ST110 and ends the process.

### ST110:

The processing unit 50 determines which of the first stage S1 to the fourth stage S4 shown in FIG. 2 is located on the basis of the time elapsed since the start of the motor 6 (the value of “n”).

### ST115:

The load calculation unit 52 calculates a calculated load F(n) based on the motor current Im (n) detected by the current detection unit 30.

### ST120:

The reference value calculation unit 53 calculates the weighted average result of the calculated load F(n) calculated by the load calculation unit 52 as the reference value B(n).

### ST130:

The pinch threshold configuration unit 55 configures a pinch threshold Fth that determines the allowable range of the difference “F(n)−B(n)” between the calculated load F(n) calculated in step ST115 and the reference value B(n) calculated in step ST120.

### ST135:

When the difference “F(n)−B(n)” between the calculated load F(n) and the reference value B(n) is larger than the pinch threshold, the pinch determination unit 56 determines that the object is pinched by the opening and closing body 3.

### ST140, ST145:

When the pinch determination unit 56 determines that there is a pinch, the motor control unit 57 performs pinch prevention control to reverse the rotation of the motor 6. For example, when it is determined that a pinch occurs during a closing operation, the motor control unit 57 performs an opening operation by reversing the motor 6.

<Problem in a Case of Using a Current Average Value that does not Consider Timing at which a Ripple is Detected>

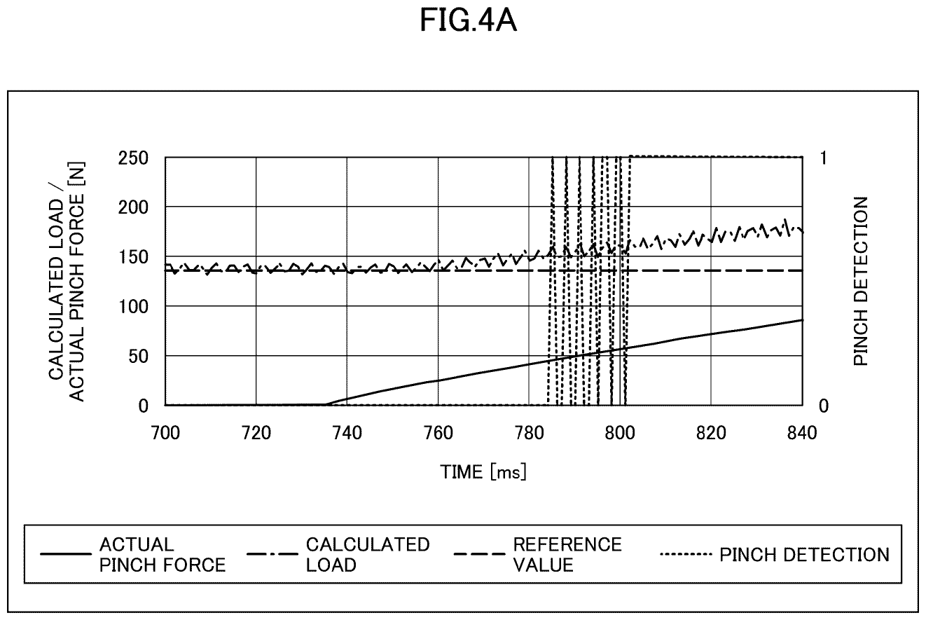

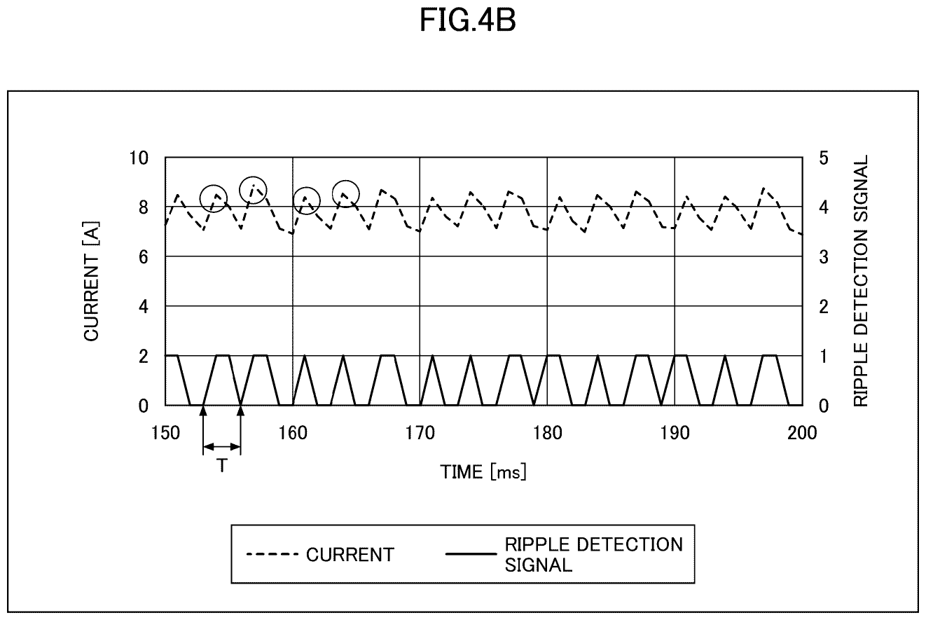

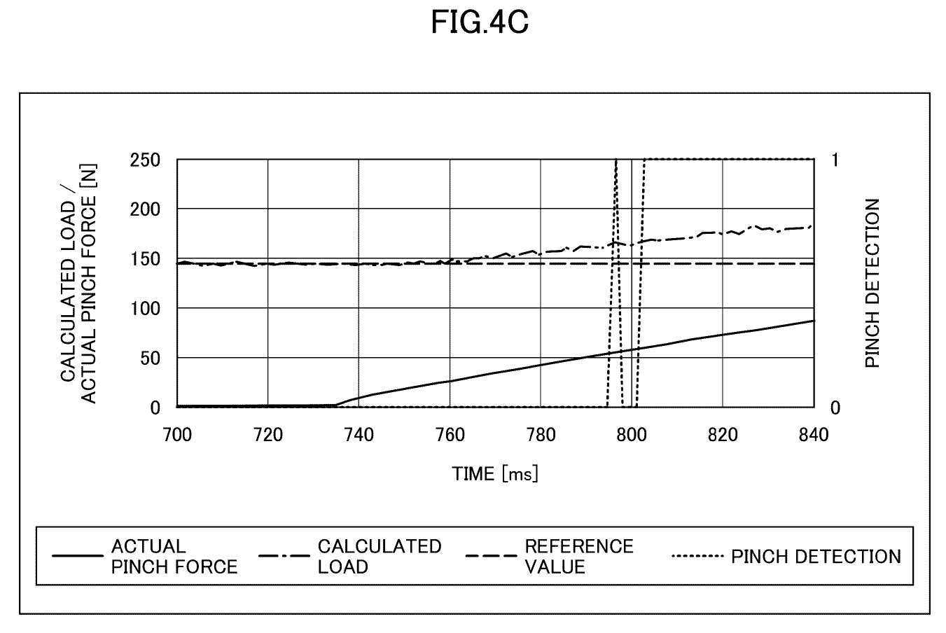

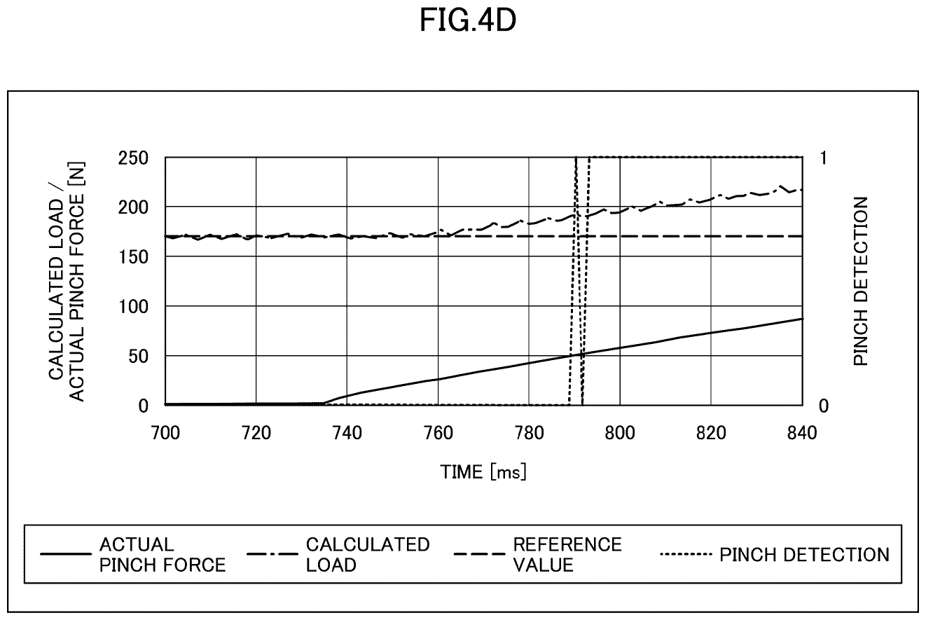

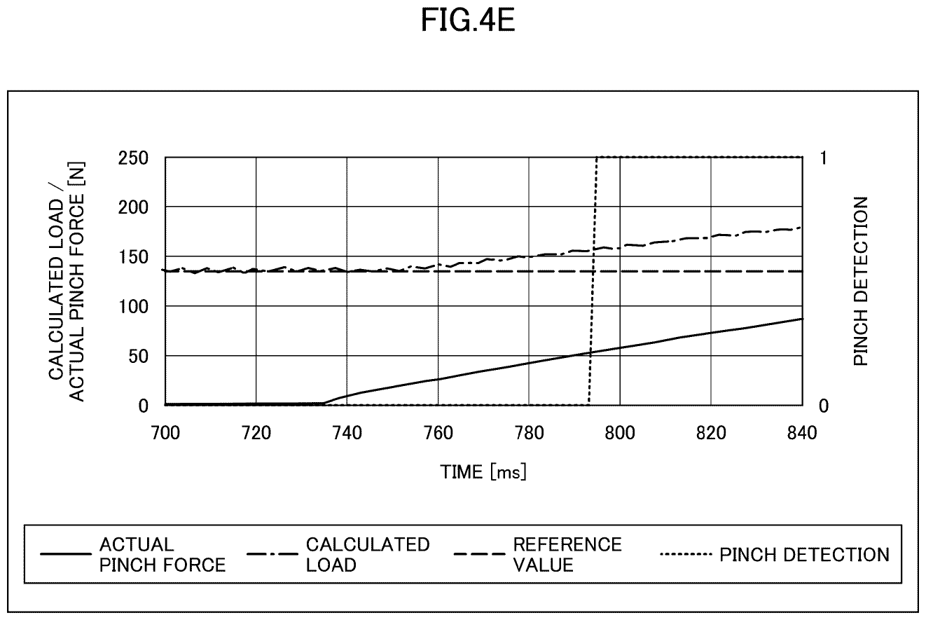

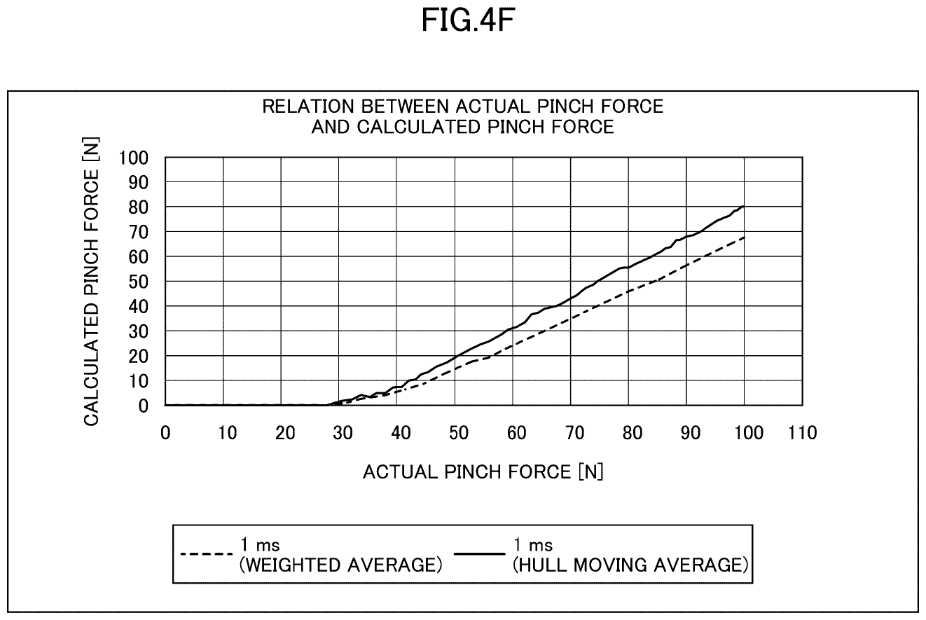

Here, with reference to FIG. 4A, a problem in a case of determining the presence or absence of pinch using a calculated load calculated on the basis of a current average value of the motor current that does not consider timing at which a ripple is detected in the comparative opening and closing control device will be described. FIG. 4A is a drawing describing the problem in the case of using the current average value that does not consider the timing at which the ripple is detected in the comparative opening and closing control device.

In FIG. 4A, the horizontal axis represents time (ms), and the left vertical axis represents the calculated load (N) and the actual pinch force (N). The calculated load is calculated by the load calculation unit 52. The actual pinch force is a measured value of the load actually applied to the window of the vehicle. The vertical axis on the right side represents the pinch detection state, 0 represents the state in which pinch is not detected, and 1 represents the state in which pinch is detected.

The current average value that does not consider the ripple detection timing is, as one example, an average value calculated for the voltage (motor current) output from the current detection unit 30, regardless of the ripple detection timing. Here, as one example, the opening and closing body position detection unit 51 of the processing unit 50 uses, as the current average value, the average value of the motor current acquired 10 times in a 100 μs period.

In the opening and closing control device to measure the position of the opening and closing body (window) using ripples, a large ripple is generated in order to prevent a ripple detection failure, and the magnitude of the current varies depending on the measurement timing.

In FIG. 4A, the actual pinch force starts to increase approximately 735 ms, and the calculated load starts to increase slightly later. When the current average value was used without considering the ripple detection timing, the calculated load showed a jagged and unstable characteristic. In addition, the state of the pinch detection changed once to 1 at approximately 780 ms, returned immediately to 0, and again changed to 1. Thus, since the state of the pinch detection is not stable, the pinch detection is difficult, and it is necessary to stabilize the pinch detection state by using a strong filter. As a compensation, detection of the occurrence of the pinch may be delayed.

### <Solution 1>

FIG. 4B is a drawing describing one example of solution 1. In FIG. 4B, the horizontal axis represents the time (ms), the vertical axis on the left represents the motor current output from the current detection unit 30, and the vertical axis on the right represents the ripple detection signal output from the ripple detection unit 35. The rising timing of the ripple detection signal corresponds to the rising timing of the ripple in the motor current. FIG. 4B shows an example of operation in a state where the voltage value of the battery is 16 V and a pinch force of 10 (N/mm) occurs at room temperature.

In solution 1, the opening and closing body position detection unit 51 acquires the motor current during the rising duration of the ripple detection signal from the current detection unit 30, and the load calculation unit 52 calculates the calculated load based on the motor current during the rising duration of the ripple detection signal. In FIG. 4B, the motor current during the rising duration of the ripple detection signal is indicated by a circle. By using the motor current during the rising duration of the ripple detection signal, the effect of the ripple can be reduced.

FIG. 4C is a drawing describing one example of an effect of solution 1. In FIG. 4C, the horizontal axis represents time (ms), and the left vertical axis represents calculated load (N) and actual pinch force (N). The horizontal axis and the right and left vertical axes in FIG. 4C are the same as those in FIG. 4A. FIG. 4C shows an example of operation in a state where the voltage value of the battery is 16 V and a pinch force of 10 (N/mm) occurs at room temperature.

The actual pinch force starts to increase at approximately 735 ms, and the calculated load starts to increase a little later. When the motor current during the rising duration of the ripple detection signal was used, the calculated load showed a stable characteristic with very little jaggedness. In addition, the state of the pinch detection changed once to 1 at approximately 790 ms, and then immediately returned to 0. After the transition to 1 again, it stabilized at 1. Thus, since the state of the pinch detection was stabilized, the pinch detection was easy. Since the number of times of returning to 0 after the state of the pinch detection changed to 1 is small, the pinch detection accuracy is improved.

By using the motor current during the rising duration of the ripple detection signal, the current value can be measured at the same phase with respect to the ripple period, and the relative magnitude of the current can be accurately measured. Also, since the current can be accurately measured in one measurement, a pinch determination can be quickly performed.

Although the solution 1 using the motor current during the rising duration of the ripple detection signal has been described here, the motor current during the falling duration of the ripple detection signal may be used.

### <Solution 2>

FIG. 4D is a drawing describing one example of solution 2. In FIG. 4D, the horizontal axis represents time (ms), and the left vertical axis represents the calculated load (N) and the actual pinch force (N). The horizontal axis and the right and left vertical axes in FIG. 4D are the same as those in FIGS. 4A and 4C. FIG. 4D shows one example of an operation in a state where the voltage value of the battery is 16 V and the pinch force of 10 (N/mm) is generated at room temperature.

In solution 2, the opening and closing body position detection unit 51 acquires the maximum value of the motor current in the duration T from the rise to the fall of the ripple detection signal in FIG. 4B from the current detection unit 30, and the load calculation unit 52 calculates the calculated load based on the maximum value of the motor current in the duration T. The duration T is a duration from when the ripple detection unit 35 detects the ripple of the motor current to when the next ripple is detected. By using the maximum value of the motor current in the duration T, the effect of the ripple can be reduced.

The actual pinch force starts to increase at approximately 735 ms, and the calculated load starts to increase a little later. When the maximum value of the motor current in the duration T was used, the calculated load showed stable characteristics with less jagged edges. In addition, the pinch detection state transitioned once to 1 approximately 790 ms, and then immediately returned to 0. After the transition to 1 again, the pinch detection state stabilized at 1. As described above, since the pinch detection state has stabilized, pinch detection is easy. The number of times the pinch detection state returns to 0 after the transition to 1 is small, and since the pinch detection state immediately stabilizes, the pinch detection accuracy is improved.

In addition, when the time required from the time when the ripple detection unit 35 detects the ripple to the time when the magnitude of the current is measured cannot be ignored, the relative magnitude of the current can be accurately measured by using the maximum value or the minimum value.

Although the mode of using the maximum value of the motor current in the duration T has been described in solution 2, the minimum value of the motor current in the duration T may be used. That is, the opening and closing body position detection unit 51 may acquire the minimum value of the motor current during the duration T from the current detection unit 30, and the load calculation unit 52 may calculate the calculated load based on the minimum value of the motor current during the duration T.

### <Solution 3>

FIG. 4E is a drawing describing one example of solution 3. In FIG. 4E, the horizontal axis represents time (ms), and the left vertical axis represents the calculated load (N) and the actual pinch force (N). The horizontal axis and the right and left vertical axes in FIG. 4E are the same as those in FIGS. 4A, 4C, and 4D. FIG. 4E shows an example of operation in a state where the voltage value of the battery is 16 V and a pinch force of 10 (N/mm) occurs at room temperature.

In solution 3, the opening and closing body position detection unit 51 acquires the average value of the motor current in the duration T from the rise to the fall of the ripple detection signal in FIG. 4B from the current detection unit 30, and the load calculation unit 52 calculates the calculated load based on the average value of the motor current in the duration T. By using the average value of the motor current in the duration T, the effect of the ripple can be reduced.

The actual pinch force starts to increase at approximately 735 ms, and the calculated load starts to increase a little later. When the average value of the motor current in the duration T was used, the calculated load showed very stable characteristics with little jagged marks. In addition, the pinch detection state transitioned once to 1 at approximately 790 ms, and then stabilized at 1. Thus, since the pinch detection state was stabilized, pinch detection is easy. The number of times that the pinch detection state returns to 0 after the transition to 1 is small, and since the pinch detection state is stabilized immediately, the pinch detection accuracy is improved.

In addition, when the noise is large, the effect of the ripple can be suppressed by using the average value of the motor current in the duration T, and the magnitude of the current can be measured with high accuracy.

### <Solution 4>

In solution 4, when the opening and closing body position detection unit 51 calculates the position of the openable and closable body based on the motor current, a hull moving average of the motor current is calculated, and the load calculation unit 52 calculates the calculated load based on the hull moving average of the motor current. The hull moving average is an example of a weighted moving average.

FIG. 4F is a drawing illustrating one example of an effect of solution 4. In FIG. 4F, the horizontal axis represents the actual pinch force (N), and the vertical axis represents the calculated pinch force (N). The calculated pinch force is the force obtained by subtracting the reference value from the calculated load.

In FIG. 4F, the calculated pinch force calculated using the calculated load calculated based on the weighted average of the motor current calculated by the general weighted average is shown by a broken line, and the calculated pinch force calculated using the calculated load calculated based on the hull moving average of the motor current calculated by the hull moving average is shown by a solid line. In the general weighted average, the weighted average of the motor current was calculated every 1 ms, and in the hull moving average, the hull moving average of the motor current was calculated every 1 ms.

When the calculated load calculated based on the weighted average of the motor currents calculated by the general weighted average when the calculated pinch force becomes 50 N was compared with the calculated load calculated based on the hull moving average of the motor currents calculated by the hull moving average when the calculated pinch force becomes 50 N, the former was 87 N and the latter was 75 N.

Thus, by calculating the calculated load based on the hull moving average of the motor currents, it is possible to obtain a quick response to a change in the actual pinch force and a large margin for forced reversal during upward movement (closing action) of the window.

The hull moving average of the motor currents can be calculated by the opening and closing body position detection unit 51 based on the current value of the current measured by the current detection unit 30 using the following formula (3).

$$\begin{matrix}[ Formula 3 ] & \\ Inew = \frac{( M - 1 ) \times Iold + Imeasure}{M} \times 2 - \frac{( 2 \times M - 1 ) \times Iold + Imeasure}{2 \times M} & ( 3 )\end{matrix}$$

Inew is the current value calculated by the hull moving average. M is the weight of Imeasure in the hull moving average. Iold is the current value calculated by the previous hull moving average, and Imeasure is the current value of the latest current measured by the current detection unit 30.

The optimum M was found by changing the temperature, the voltage of the battery, and the weight M. For example, when M=20, a reversal load of approximately 70 N could be realized at room temperature (when the battery voltage is high and the rotation speed of the motor 6 is high). However, since the ripple could not be completely removed at low temperature (when the battery voltage is low and the rotation speed of the motor 6 is low), the reversal load increased to approximately 80 N.

Furthermore, when M=70, the effect of ripple could be suppressed at low temperature (when the battery voltage is low and the rotation speed of the motor 6 is low), and the reversal load became approximately 80 N. However, at room temperature (when the battery voltage is high and the rotation speed of the motor 6 is high), the reference value followed the calculated load, and the reversal load became approximately 80 N.

Considering these facts, it was considered that a reversal load of 70-80 N could be realized by switching the weight according to the magnitude of the voltage. It was confirmed by experiments that sufficient accuracy could be obtained even if the weight M was switched only by the voltage, because the voltage of the battery mainly changes with the temperature.

As a result, it is understood that the weight M of Imeasure in the hull moving average may be configured to M1 when the voltage measured by the voltage detection unit 20 is equal to or greater than the threshold, and to M2 which is greater than M1 when the voltage measured by the voltage detection unit 20 is less than the threshold.

By using the hull moving average, the effect of measurement errors due to noise and the like can be reduced. In addition, since the delay can be reduced, the determination speed of pinch becomes faster.

### <Detected Current Acquisition Process of Solution 1-4>

The detected current acquisition process of solution 1-4 will be described below. The detected current acquisition process of each solution is a subroutine of the detected current acquisition process of step ST101 in FIG. 3.

### <Solution 1>

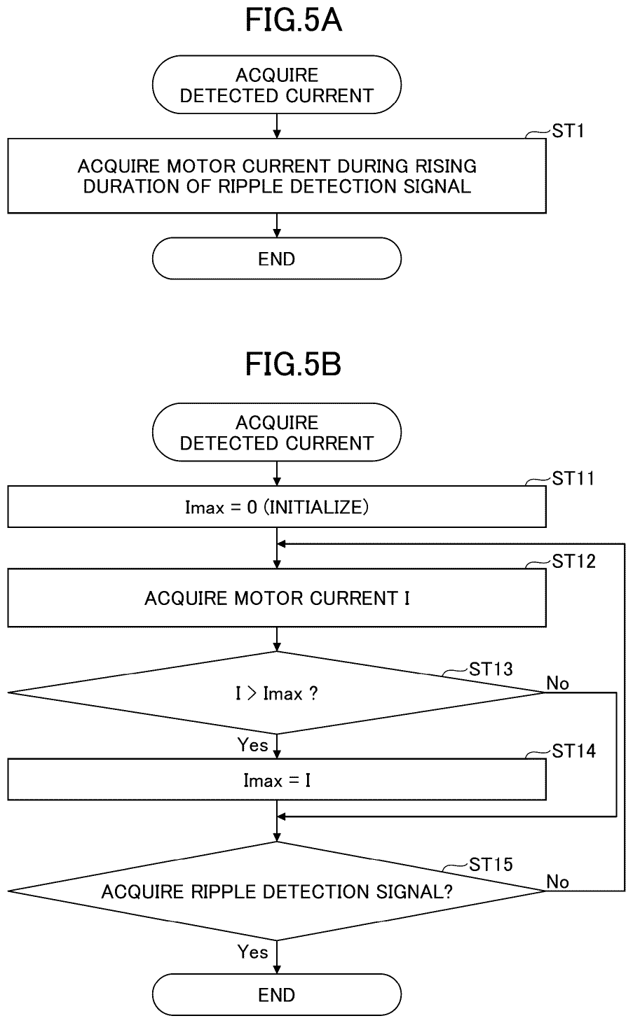

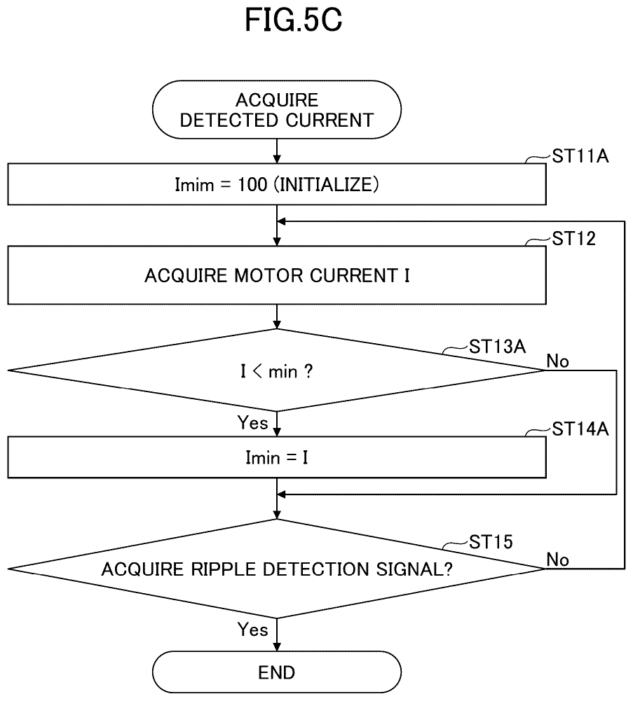

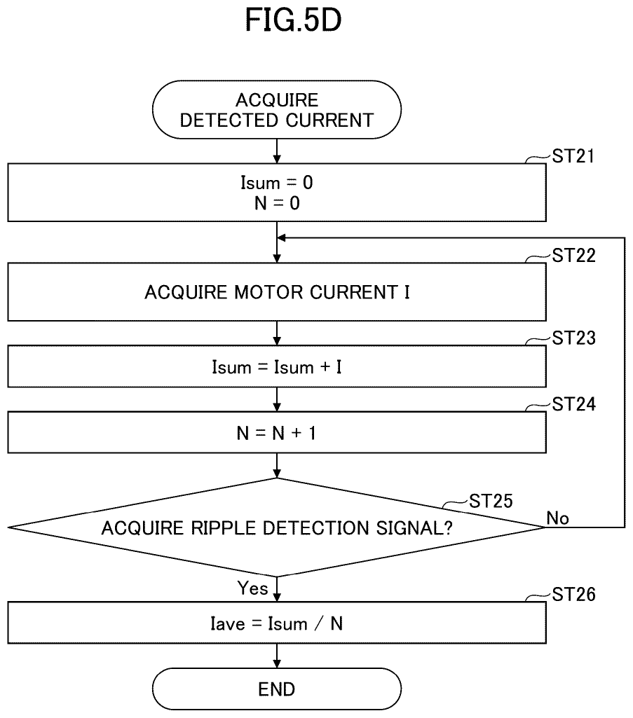

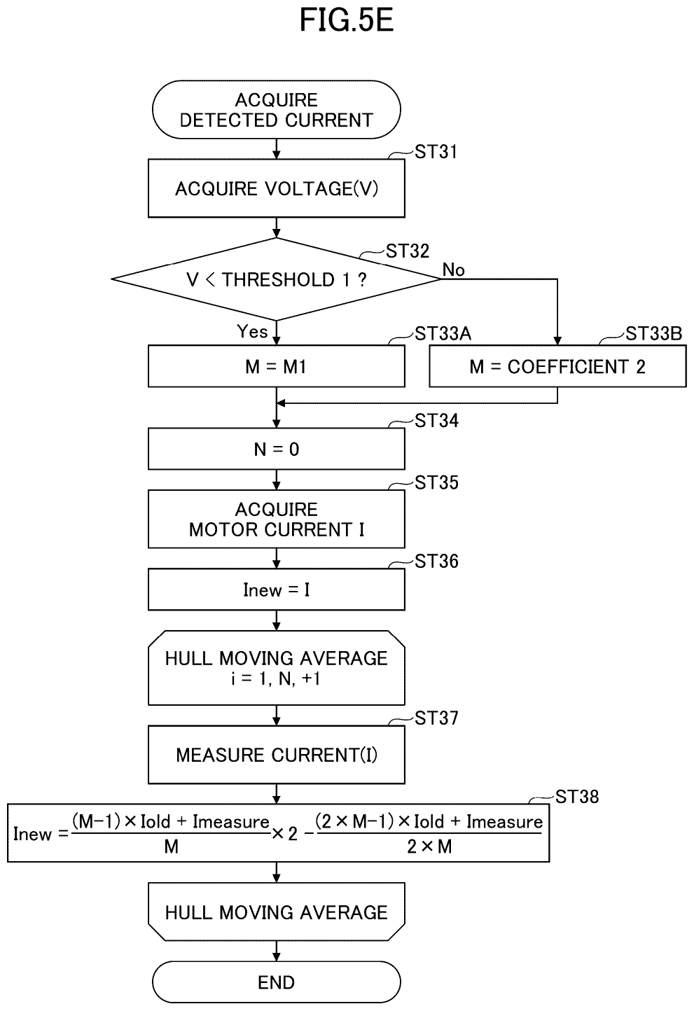

FIG. 5A is a flowchart illustrating one example of the detected current acquisition process according to solution 1.

When the detected current acquisition process is started, the opening and closing body position detection unit 51 acquires the motor current during the rising duration of the ripple detection signal from the current detection unit 30 (step ST1). Thus, the detected current acquisition process of the solution 1 is completed (END).

More specifically, when the detection signal is input from the ripple detection unit 35, the opening and closing body position detection unit 51 acquires the motor current from the current detection unit 30. In this way, the motor current during the rising duration of the ripple detection signal can be acquired.

### <Process of Solution 2>

FIG. 5B is a flowchart illustrating one example of the detected current acquisition process according to solution 2.

Upon acquiring the ripple detection signal, the opening and closing body position detection unit 51 starts the detected current acquisition process, and initializes the maximum motor current Imax representing the maximum value of the motor current (step ST11). That is, Imax=0. When the ripple detection signal is acquired, it is at the rising timing of the ripple detection signal.

The opening and closing body position detection unit 51 acquires the motor current I from the current detection unit 30 (step ST12).

The opening and closing body position detection unit 51 determines whether the acquired motor current I is larger than the maximum motor current Imax (step ST13).

When the opening and closing body position detection unit 51 determines that the acquired motor current I is larger than the maximum motor current Imax (step ST13: Yes), the acquired motor current I is substituted for the maximum motor current Imax (step ST14). That is, Imax=I.

The opening and closing body position detection unit 51 determines whether the ripple detection signal has been acquired (step ST15). This is to determine whether the end of the duration T (the fall of the ripple detection signal) has arrived.

When the opening and closing body position detection unit 51 determines that the ripple detection signal has been acquired (step ST15: Yes), the detected current acquisition process in solution 2 is finished (END).

When the opening and closing body position detection unit 51 determines that the motor current I acquired in step ST13 is not larger than the maximum motor current Imax (step ST13: No), the flow proceeds to step ST15.

When the opening and closing body position detection unit 51 determines in step ST15 that the ripple detection signal has not been acquired (step ST15: No), the flow returns to step ST12. As a result, the opening and closing body position detection unit 51 obtains the motor current I from the current detection unit 30 again in step ST12.

As described above, the opening and closing body position detection unit 51 acquires the maximum value of the motor current in the duration T from the rise to the fall of the ripple detection signal.

### <Process of a Variation of Solution 2>

FIG. 5C is a flowchart illustrating one example of the detected current acquisition process according to a variation of solution 2. The variation of solution 2 is different in that the minimum value of the motor current in the duration T is used instead of the maximum value of the motor current in the duration T.

When the ripple detection signal is acquired, the opening and closing body position detection unit 51 starts the detected current acquisition process and initializes the minimum motor current Imin representing the minimum value of the motor current (step ST11A). That is, Imin=100. The time when the ripple detection signal is acquired is the rising timing of the ripple detection signal.

The opening and closing body position detection unit 51 acquires the motor current I from the current detection unit 30 (step ST12).

The opening and closing body position detection unit 51 determines whether the acquired motor current I is smaller than the minimum motor current Imin (step ST13A).

When the opening and closing body position detection unit 51 determines that the acquired motor current I is smaller than the minimum motor current Imin (step ST13A: Yes), the acquired motor current I is substituted for the minimum motor current Imin (step ST14A). That is, Imin=I.

The opening and closing body position detection unit 51 determines whether the ripple detection signal has been acquired (step ST15). This is to determine whether the end of the duration T (the fall of the ripple detection signal) has arrived.

When the opening and closing body position detection unit 51 determines that the ripple detection signal has been acquired (ST15: Yes), it ends the detected current acquisition process in the modified example of solution 2 (END).

When the opening and closing body position detection unit 51 determines that the motor current I acquired in step ST13A is not smaller than the minimum motor current Imin (ST13A: No), the flow proceeds to step ST15.

When the opening and closing body position detection unit 51 determines in step ST15 that the ripple detection signal has not been acquired (ST15: No), the flow returns to step ST12. As a result, the opening and closing body position detection unit 51 acquires the motor current I from the current detection unit 30 again in step ST12.

As described above, the opening and closing body position detection unit 51 acquires the minimum value of the motor current in the duration T from the rise to the fall of the ripple detection signal.

### <Process of Solution 3>

FIG. 5D is a flowchart illustrating one example of the detected current acquisition process according to solution 3.

When the opening and closing body position detection unit 51 acquires the ripple detection signal, it starts the detected current acquisition process, and initializes the total motor current Isum representing the total value of the motor current in the duration T and the number of times N of acquisition of the motor current I (step ST21). That is, Isum=0 and N=0. The time when the ripple detection signal is acquired is the rising timing of the ripple detection signal.

The opening and closing body position detection unit 51 acquires the motor current I from the current detection unit 30 (step ST22).

The opening and closing body position detection unit 51 adds the acquired motor current I to the total motor current Isum (step ST23). That is, Isum=Isum+I.

The opening and closing body position detection unit 51 increments the acquisition count N of the motor current I (step ST24). That is, N=N+1.

The opening and closing body position detection unit 51 determines whether the ripple detection signal has been acquired (step ST25). This is to determine whether the end of the duration T (the fall of the ripple detection signal) has arrived.

If it is determined that the ripple detection signal has not been acquired (step ST25: No), the opening and closing body position detection unit 51 returns the flow to step ST22. This is to acquire the motor current I again from the current detection unit 30.

When the opening and closing body position detection unit 51 determines that the ripple detection signal has been acquired (ST25: Yes) in step ST25, it calculates the average value Iave of the motor current in the duration T (step ST26). Iave=Isum/N. Thus, the detected current acquisition process in solution 3 is completed (END).

As described above, the opening and closing body position detection unit 51 acquires the average value of the motor current in the duration T from the rise to the fall of the ripple detection signal.

### <Process of Solution 4>

FIG. 5E is a flowchart illustrating one example of the detected current acquisition process according to solution 4.

When the opening and closing body position detection unit 51 starts the detected current acquisition process, it acquires the voltage (motor voltage) supplied to the motor 6 from the voltage detection unit 20 (step ST31).

The opening and closing body position detection unit 51 determines whether the motor voltage is less than the threshold 1 (step ST32).

When the opening and closing body position detection unit 51 determines that the motor voltage is less than the threshold 1 (step ST32: Yes), the hull moving average weight M is configured as the weight M1 (step ST33A). That is, M=M1.

When the opening and closing body position detection unit 51 determines that the motor voltage is not less than the threshold 1 (step ST32: No), the hull moving average weight M is configured as the weight M2 (step ST33B). That is, M=M2. As described above, M1<M2.

Upon completion of the process of step ST33A or step ST33B, the opening and closing body position detection unit 51 resets the number of repetitions N (step ST34). That is, N=0.

The opening and closing body position detection unit 51 acquires the motor current I from the current detection unit 30 (step ST35).

The opening and closing body position detection unit 51 configures the calculated motor current Inew based on the hull moving average as the motor current I obtained in step ST35 (step ST36). That is, Inew=I.

The opening and closing body position detection unit 51 executes a subroutine process for calculating a calculated value Inew of the motor current based on the hull moving average. This subroutine process repeats steps ST37 and ST38 N times.

The opening and closing body position detection unit 51 obtains the motor current I from the current detection unit 30 (step ST37). The motor current I obtained in step ST37 is the current value Imeasure of the latest current measured by the current detection unit 30.

The opening and closing body position detection unit 51 calculates the calculated motor current Inew by the hull moving average using the following formula 4 (step ST38). M1 or M2 is substituted for the weight M. Iold is the calculated current value by the previous hull moving average. In other words, Iold is the previous Inew.

$$\begin{matrix}[ Formula 4 ] & \\ Inew = \frac{( M - 1 ) \times Iold + Imeasure}{M} \times 2 - \frac{( 2 \times M - 1 ) \times Iold + Imeasure}{2 \times M} & ( 4 )\end{matrix}$$

After calculating the calculated value Inew of the motor current based on the hull moving average, the opening and closing body position detection unit 51 ends the detected current acquisition process in solution 4 (END).

As described above, the opening and closing body position detection unit 51 acquires the calculated value Inew of the motor current based on the hull moving average.

Next, each process of steps ST120 to ST135 shown in FIG. 3 will be described in more detail with reference to a flowchart or the like.

### <Reference Value Calculation>

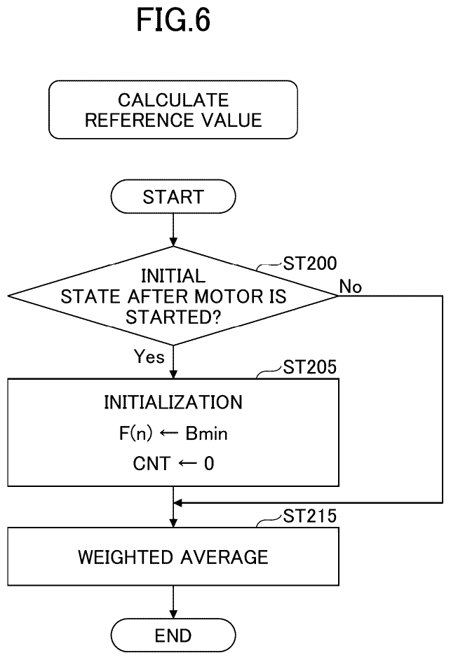

FIG. 6 is a flowchart for explaining calculation of a reference value B (FIG. 3, ST120).

In the case of an initial state after the motor 6 is started (ST200, Yes), the reference value calculation unit 53 initializes each variable and state used for calculation of the reference value B (ST205). For example, the reference value calculation unit 53 configures the reference value B(n) as the minimum load Bmin.

Next, the reference value calculation unit 53 performs a weighted average (formula 2) of the new calculated load F(n) and the past reference value B (n−1), and calculates the result as a new reference value B(n) (ST215).

### <Weighted Average Process>

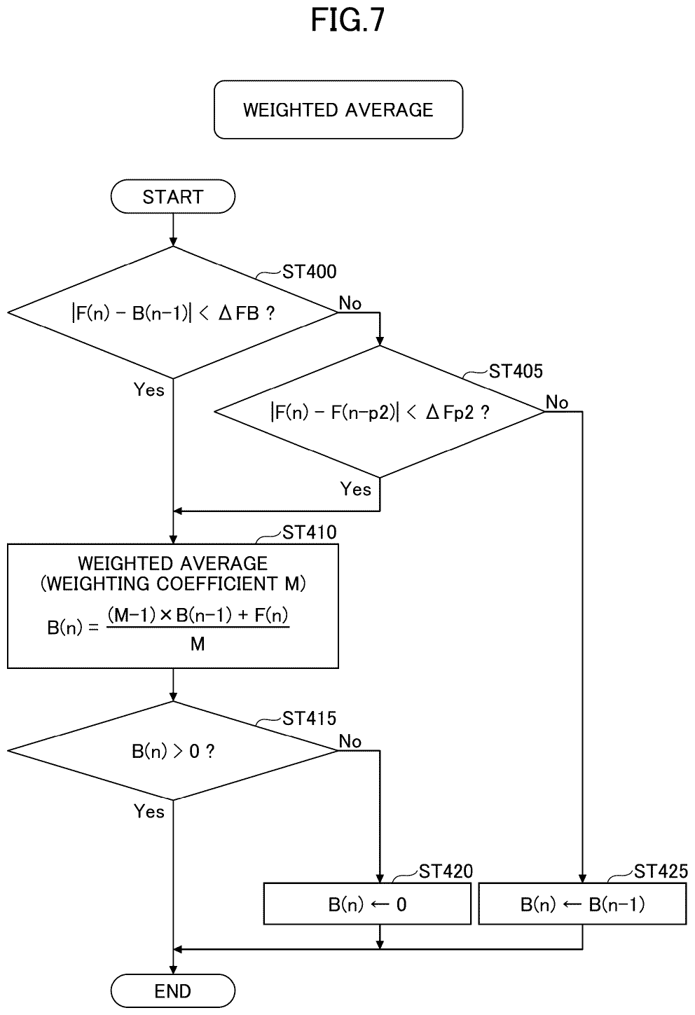

FIG. 7 is a flowchart to describe a weighted average process (FIG. 3, ST120) in the calculation of the reference value.

The reference value calculation unit 53 compares the difference “|F(n)−B(n−1)|” between the new calculated load F(n) and the past reference value B(n−1) with the difference threshold ΔFB (ST400). If the difference “|F(n)−B(n−1)|” between the new calculated load F(n) and the past reference value B(n−1) is smaller than the difference threshold ΔFB (ST400, Yes), the reference value calculation unit 53 calculates the reference value B(n) by the weighted average (formula 2) (ST410).

If the difference “|F(n)−B(n−1)|” between the new calculated load F(n) and the past reference value B(n−1) is equal to or larger than the difference threshold ΔFB (ST400, No), the reference value calculation unit 53 compares the change amount “|F(n)−F(n−p2)|” of the calculated load F per predetermined time p2 with the change amount threshold ΔFp2 (ST405). If the change amount “|F(n)−F(n−p2)|” of the calculated load F is smaller than the change amount threshold ΔFp2 (ST405, Yes), the reference value calculation unit 53 calculates the reference value B(n) by the weighted average (formula 2) (ST410).

If the reference value B(n) calculated by the weighted average (formula 2) is equal to or smaller than zero (ST415, No), the reference value calculation unit 53 configures the reference value B(n) as zero (ST420).

When the difference “|F(n)−B(n−1)|” between the new calculated load F(n) and the past reference value B(n−1) is equal to or greater than the difference threshold ΔFB and the change amount “|F(n)−F(n−p2)|” of the calculated load F per predetermined time p2 is equal to or greater than the change amount threshold ΔFp2 (when the result is “No” in both ST400 and ST 405), the reference value calculation unit 53 matches the new reference value B(n) with the past reference value B(n−1) (ST425). That is, the reference value calculation unit 53 stops updating the reference value B(n).

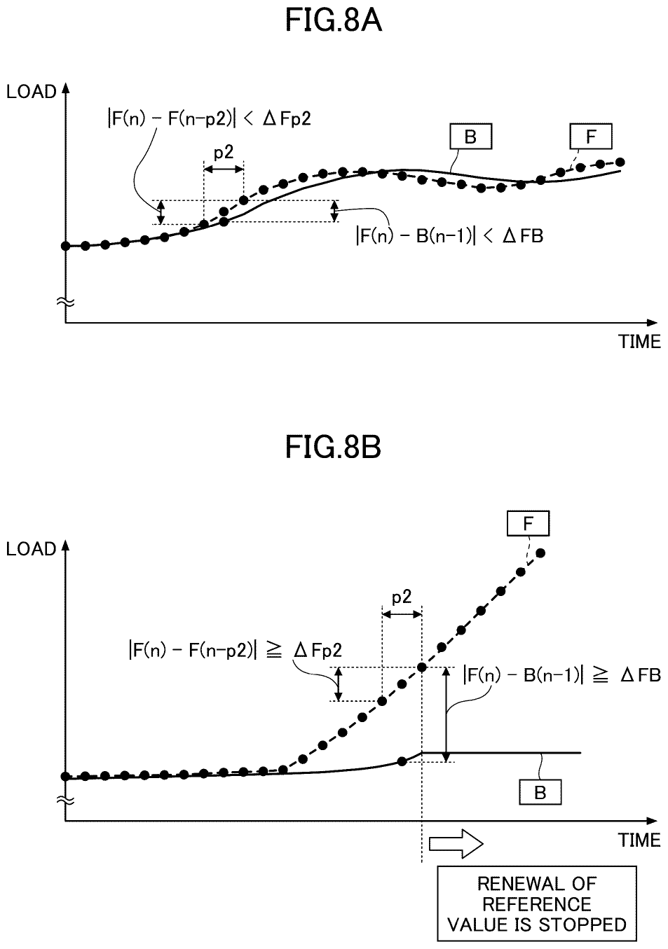

FIGS. 8A and 8B are drawings illustrating examples of weighted average processes (FIG. 7). FIG. 8A illustrates an example in which a reference value B is calculated by the weighted average process. FIG. 8B illustrates an example in which a renewal of the reference value B is stopped due to a sudden rise in the calculated load F.

As shown in FIG. 8A, when the difference “|F(n)−B(n−1)|” between the new calculated load F(n) and the past reference value B(n−1) is smaller than the difference threshold ΔFB or when the change amount “|F(n)−F(n−p2)|” of the calculated load F per predetermined time p2 is smaller than the change amount threshold ΔFp2, the reference value calculation unit 53 calculates the reference value B(n) by the weighted average (formula 2). In this case, the reference value B(n) generally follows the calculated load F(n).

As shown in FIG. 8B, when a pinch occurs, the difference between the new calculated load F(n) and the past reference value B(n−1) suddenly increases, and the change in the calculated load F with time tends to increase rapidly. Therefore, by stopping the update of the reference value B in such a case, the difference between the calculated load F and the reference value B quickly increases, and the occurrence of the pinch can be quickly detected.

### <Configuration of a Pinch Threshold>

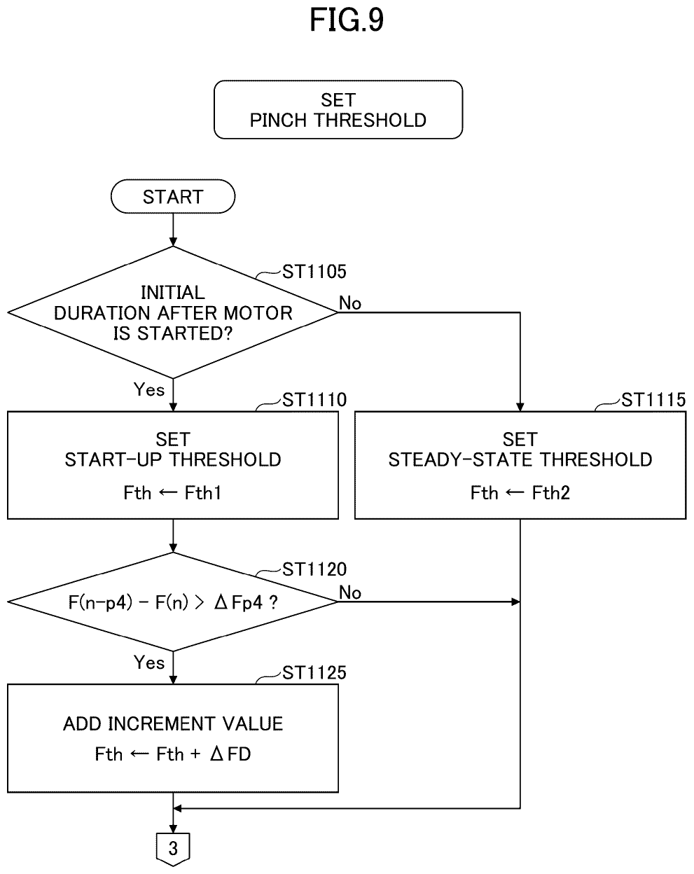

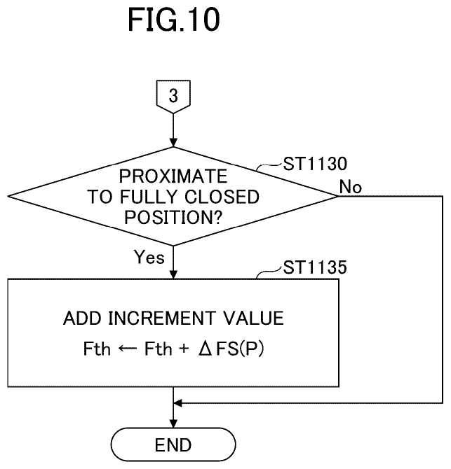

FIG. 9 and FIG. 10 are flowcharts to describe a configuration (FIG. 3, ST130) of a pinch threshold.

The pinch threshold configuration unit 55 sets the base value of the pinch threshold Fth as the start-up threshold Fth1 in an initial duration (for example, the first stage S1 and the second stage S2) after the motor 6 is started (ST1105, Yes) (ST1100), and configures the base value of the pinch threshold Fth to the steady-state threshold Fth2 in a duration after the initial duration (ST1105, No) (ST1115). Since the start-up threshold Fth1 has a larger value than the steady-state threshold Fth2, the fluctuation of the calculated load F(n) in the initial duration does not tend to be erroneously determined as a pinch.

In addition, the pinch threshold configuration unit 55 determines whether or not the decrease “F(n−p4)−F(n)” of the calculated load F per predetermined time p4 exceeds the initial decrease threshold ΔFp4 in the initial duration (ST1105, Yes) after the motor 6 is started (ST1120). If the decrease “F(n−p4)−F(n)” exceeds the initial decrease threshold ΔFp4, the pinch threshold configuration unit 55 temporarily increases the pinch threshold Fth. That is, the pinch threshold configuration unit 55 adds the increment value ΔFD to the pinch threshold Fth only during the initial duration (ST1125).

Next, when the position of the opening and closing body 3 detected by the opening and closing body position detection unit 51 is in a predetermined proximate range of the fully closed position (ST1130, Yes), the pinch threshold configuration unit 55 adds to the pinch threshold Fth an increment value ΔFS(P) that increases as the position P of the opening and closing body 3 approaches the fully closed position (ST1135).

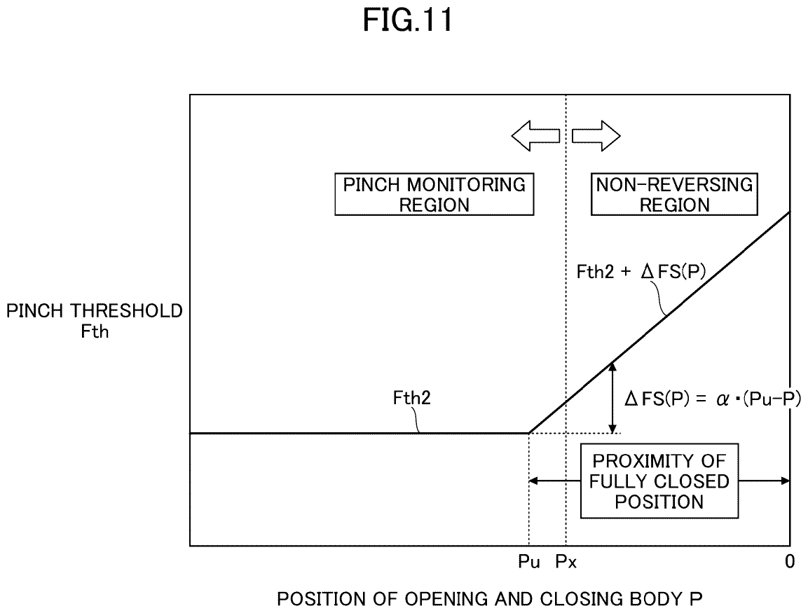

FIG. 11 is a drawing illustrating an example of the configuration of the pinch threshold Fth in a proximate range of the fully closed position. In the example of FIG. 11, the position where the value of the position P is “0” is defined as the fully closed position, and the position moves away from the fully closed position as the value of the position P increases positively (from right to left in the figure). The increment value ΔFS(P) is, for example, a linear function of the position P, and is expressed by the following formula.

$$\begin{matrix}[ Formula 5 ] & \\ Δ FS ( P ) = α \times ( Pu - P ) & ( 5 )\end{matrix}$$

In formula 5, “ax” is a coefficient representing the slope of the linear function. The proximate range of the fully closed position to which the increment value ΔFS(P) is added is a range from “0” to “Pu”, and the increment value ΔFS(P) is 0 when the value of the position P is “Pu”. In the example of FIG. 11, a boundary “Px” between the pinch monitoring region and the non-inversion region is included in the proximate range (0 to Pu) of the fully closed position to which the increment value ΔFS(P) is added.

### <Pinch Determination>

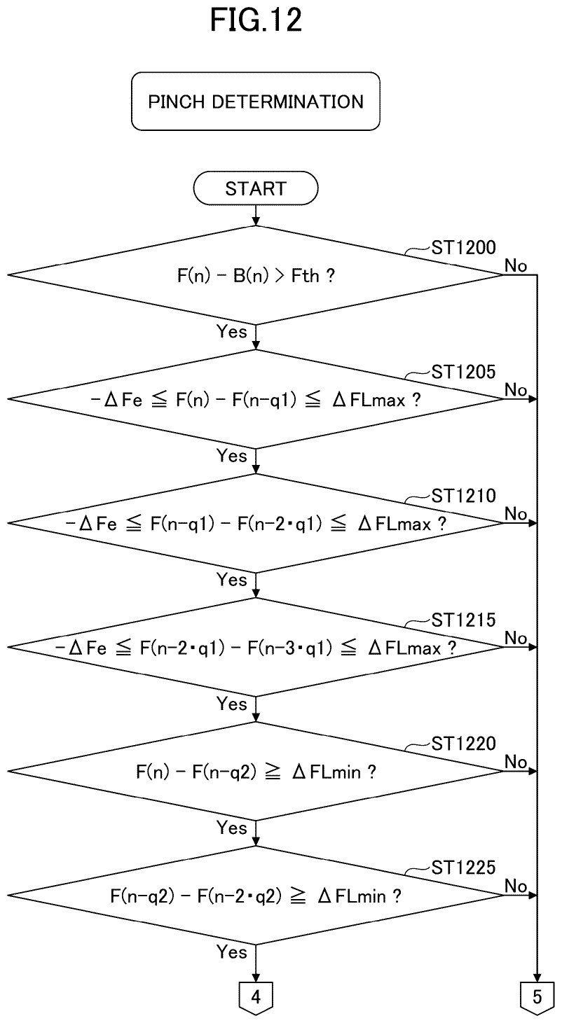

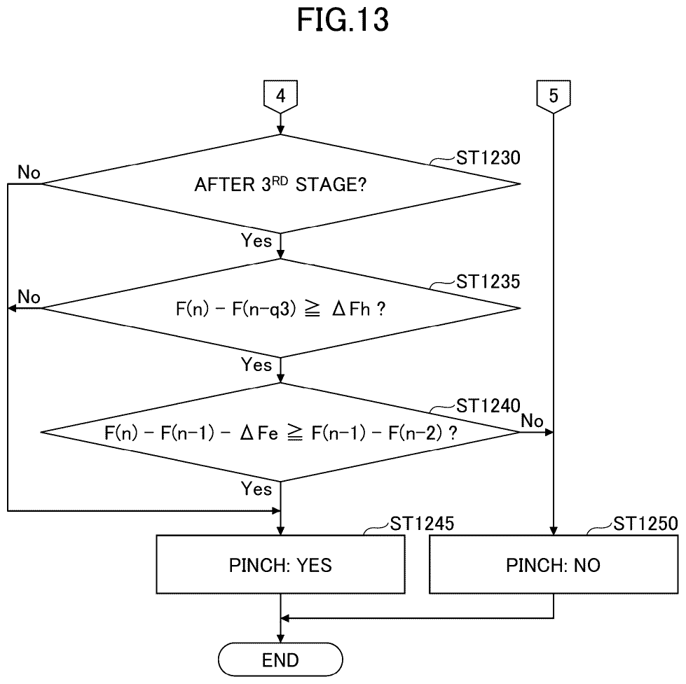

FIG. 12 and FIG. 13 are flowcharts to describe the pinch determination (FIG. 3, ST135).

The pinch determination unit 56 compares the difference “F(n)−B(n)” between the calculated load F(n) and the reference value B(n) with the pinch threshold Fth, and determines that there is no pinch when the difference “F(n)−B(n)” between the calculated load F(n) and the reference value B(n) is equal to or less than the pinch threshold Fth (ST1200, No) (ST1250).

When the difference “F(n)−B(n)” between the calculated load F(n) and the reference value B(n) is larger than the pinch threshold Fth (ST1200, Yes), the pinch determination unit 56 further determines whether the pattern of change of the calculated load F corresponds to a predetermined pattern of monotonic increase (ST1205 to ST1225).

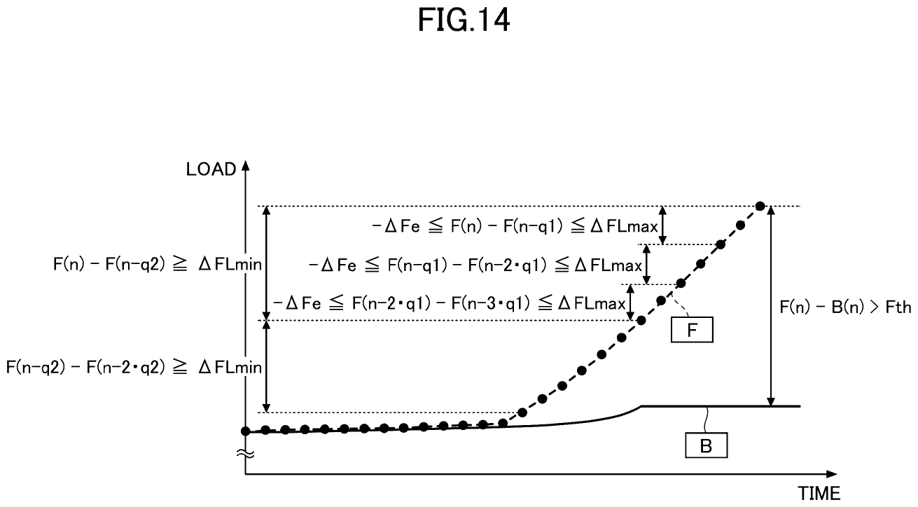

FIG. 14 is a drawing to describe conditions (ST1205 to ST1225) for monotonical increase of the calculated load F in the pinch determination. The pinch determination unit 56 determines whether or not the increased amount of the calculated load F is within a predetermined maximum change range (−ΔFe to ΔFLmax) in each of the three consecutive times q1. That is, the pinch determination unit 56 determines whether or not the increased amount of the calculated load F “F(n)−F(n−q1)” in step ST1205, the increased amount of the calculated load F “F(n−q1)−F(n−2q1)” in step ST1210, and the increased amount of the calculated load F “F(n−2q1)−F(n−3q1)” in step ST1215 are within a range from “−ΔFe” to “ΔFLmax”, respectively. If it is determined in one or more of steps ST1205-1215 that the increased amount of the calculated load F is not within the maximum change range (−ΔFe to ΔFLmax), the pinch determination unit 56 determines that there is no pinch (ST1250).

Also, the pinch determination unit 56 determines whether or not the increased amount of the calculated load F is greater than or equal to a predetermined minimum increase ΔFLmin in each of the two consecutive times q2 (>q1). That is, the pinch determination unit 56 determines whether or not the increased amount of the calculated load F “F(n)−F(n−q2)” in step ST1220 and the increased amount of the calculated load F “F(n−q2)−F(n−2q2)” in step ST1225 are greater than or equal to the minimum increase ΔFLmin. If it is determined in one or more of steps ST1220 and ST1225 that the increased amount of the calculated load F is smaller than the minimum increase ΔFLmin, the pinch determination unit 56 determines that there is no pinch (ST1250).

As described above, by using as the condition of the pinch determination whether or not the pattern of the change of the calculated load F corresponds to the pattern of monotonic increase, it is possible to reduce the cases of erroneously determining, for example, the impact of disturbance or noise as a pinch, thereby improving the accuracy of the pinch determination.

When it is determined in each of steps ST1205-1215 that the increase of the calculated load F is within the maximum change range (−ΔFe to ΔFLmax), and when it is determined in each of steps ST1220 and ST1225 that the increase of the calculated load F is equal to or greater than the minimum increase ΔFLmin, the pinch determination unit 56 further proceeds to the determination of steps ST1230 to ST1240.

In and after the third stage S3 in which the rotation of the motor 6 is relatively stable (ST1230, Yes), the pinch determination unit 56 determines whether the increase of the calculated load F “F(n)−F(n−q3)” per predetermined time q3 is equal to or greater than the threshold ΔFh indicating the occurrence criterion of pinch of a hard object (ST1235). When the increase of the calculated load F “F(n)−F(n−q3)” is equal to or greater than the threshold ΔFh (ST1235, Yes), the pinch determination unit 56 determines whether the change of the calculated load F is accelerating (ST1240). That is, the pinch determination unit 56 compares a value obtained by subtracting a fixed value “ΔFe” corresponding to an error such as noise from the most recent increase of the calculated load F “F(n)−F(n−1)” with the previous increase of the calculated load F “F(n−1)−F(n−2)”, and when the former is equal to or greater than the latter, it determines that the change of the calculated load F is accelerating (step ST1240, Yes). If it is determined in step ST1240 that the change of the calculated load F is accelerating, the pinch determination unit 56 determines that there is a pinch (ST1245); otherwise, it determines that there is no pinch (ST1250). If it is determined in step ST1230 that the change is before the third stage S3 (ST1230, No), or if it is determined in step ST1235 that the increase of the calculated load F “F(n)−F(n−q3)” is smaller than the threshold ΔFh (ST1235, No), the pinch determination unit 56 omits the determination in step ST1240 and determines that there is a pinch (ST1245).

As described above, by examining the acceleration of the change of the calculated load F(n) when the calculated load F(n) rapidly increases, it is possible to distinguish between the case where the pinch of a hard object occurs and the case where the calculated load F(n) changes due to the impact of a disturbance or the like, thereby reducing the erroneous determination of the pinch.

### <Effects>

An opening and closing control device 100 is an opening and closing control device 100 to control an opening and closing operation of an opening and closing body by a motor 6, and is provided with a current detection unit 30 (current measuring unit) for measuring a current value of the current flowing through the motor 6, a ripple detection unit 35 to detect a ripple of the current, a load calculation unit 52 to calculate a load in the opening and closing operation of the opening and closing body based on the current value of the current, an opening and closing body position detection unit 51 (position calculation unit) to calculate the position of the opening and closing body based on the ripple of the current, and a pinch determination unit 56 to determine that an object has been pinched by the opening and closing body based on the position of the opening and closing body and the load, wherein the opening and closing body position detection unit 51 calculates the position of the opening and closing body based on the current value of the current measured by the current detection unit 30 when the ripple detection unit 35 detects the ripple of the current.

In the conventional opening and closing control device to measure a position using a ripple, a large ripple is generated in order to prevent omission of detection of the ripple, and the magnitude of the current varies depending on the measurement timing. Conversely, the opening and closing control device 100 of the embodiment measures the current value at the same phase with respect to the ripple period, so that the relative magnitude of the current can be accurately measured. Since the current can be accurately measured in one measurement, the pinch determination can be quickly performed. Incidentally, the pinch is determined by a sudden increase in the current value, and any phase may be used as long as the phase is the same.

Therefore, it is possible to provide the opening and closing control device 100 capable of detecting pinch of an object by an opening and closing body whose opening and closing operation is performed by a motor with high accuracy.

The load calculation unit 52 may also calculate a load based on the current value of the current measured by the current detection unit 30 when the ripple detection unit 35 detects a current ripple. The pinch determination can be quickly performed.

The load calculation unit 52 may also calculate a load based on the maximum or minimum value of the current value measured by the current detection unit 30 during the period from when the ripple detection unit 35 detects a current ripple until the next current ripple is detected. When the time required from when the ripple detection unit 35 detects a ripple until the measurement of the magnitude of the current cannot be ignored, the relative magnitude of the current can be accurately measured by using the maximum or minimum value.

The load calculation unit 52 may also calculate a load based on the average value of the current value measured by the current detection unit 30 during the duration from when the ripple detection unit 35 detects a current ripple until the next current ripple is detected. When the noise is large, the magnitude of the current can be accurately measured by using the average value of the motor current during the duration T.

The load calculation unit 52 may also calculate the load based on a weighted moving average of the current values of the current measured by the current detection unit 30 during a fixed duration after the ripple detection unit 35 detects the ripple. When the noise is large, the magnitude of the current can be accurately measured by using a moving average of the current values during a fixed duration.

The load calculation unit 52 may also have a voltage detection unit 20 to measure the voltage supplied to the motor 6, and may configure the weight so that the weight in the weighted moving average of the current values of the latest current measured by the current detection unit 30 is increased when the voltage measured by the voltage detection unit 20 is equal to or greater than the threshold, and may configure the weight so that the weight in the weighted moving average of the current values of the latest current measured by the current detection unit 30 is smaller when the voltage measured by the voltage detection unit 20 is less than the threshold. By changing the weight, the effect of measurement errors due to noise or the like can be reduced.

The load calculation unit 52 may also calculate a weighted moving average of the current by the following formula 6 based on the current value of the current measured by the current detection unit 30.

$$\begin{matrix}[ Formula 6 ] & \\ Inew = \frac{( M - 1 ) \times Iold + Imeasure}{M} \times 2 - \frac{( 2 \times M - 1 ) \times Iold + Imeasure}{2 \times M} & ( 6 )\end{matrix}$$

Here, Inew is a calculated value of the current value by the weighted moving average, M is a weight, M1 is obtained when the voltage measured by the voltage detection unit 20 is equal to or greater than the threshold, and M2 is obtained when the voltage measured by the voltage detection unit 20 is less than the threshold, and M1<M2 is satisfied. Iold is a calculated value of the current value by the previous weighted moving average, and Imeasure is the current value of the latest current measured by the current detection unit 30.

Formula 6 partially applies the formula of the hull moving average, and the delay can be reduced. Therefore, the determination speed of the pinch is increased.

The ripple detection unit 35 may also have a BPF 36 for passing the frequency component of the ripple of the current, and a comparator 37 for comparing the reference potential with the signal passed through the BPF36. With a relatively simple circuit, the omission or incorrect detection of ripples tend to be prevented.

The comparator 37 may also output a pulse signal when the signal passed through the BPF 36 is larger than the reference potential. With a relatively simple circuit, the omission or incorrect detection of ripples tends to be prevented.

Further, every time the ripple detection unit 35 detects a ripple of the current, the current detection unit 30 may measure the current value of the current, and the load calculation unit 52 may calculate the load. The pinch determination can be quickly performed by the interruption process.

The pinch determination unit 56 includes a reference value calculation unit 53 to calculate the weighted average result of the calculated load calculated by the load calculation unit 52 as a reference value, and the pinch threshold configuration unit 55 to set the pinch threshold to determine the allowable range of the excess amount of the calculated load relative to the reference value. The pinch determination unit 56 may determine that the object is pinched by the opening and closing body when the excess amount of the calculated load relative to the reference value is larger than the pinch threshold. Even if the load to move the window in the state where a pinch does not occur changes due to the hardness or the like of the rubber of the weather strip, an appropriate reference value can be configured, and pinch can be accurately determined.

When the pinch determination unit 56 detects a pinch, the motor 6 may be rotated in reverse. Therefore, pinch can be released.

It should be noted that the present disclosure is not limited to the above embodiments, but includes various other variations.

In the above embodiments, an example is given in which the present embodiments are applied to a window opening and closing control device (power window, etc.) of a vehicle, but the present embodiments are not limited to this, and can be applied to various other opening and closing control devices such as a sunroof or a sliding door.

Although the opening and closing control device of the exemplary embodiment of the present disclosure has been described above, the present invention is not limited to these embodiments, but various variations and modifications may be made without departing from the scope of the present invention.

The present application is based on and claims priority to Japanese patent application No. 2023-143857 filed on Sep. 5, 2023 with the Japanese Patent Office, the entire contents of which are hereby incorporated by reference.

What is claimed is:

1. An opening and closing control device configured to control an opening and closing operation of an opening and closing body by a motor, comprising:
processing circuitry configured to:
measure a current value of a current flowing through the motor;
detect a ripple of the current;
calculate a load in the opening and closing operation of the opening and closing body based on the current value of the current;
calculate a position of the opening and closing body based on the ripple of the current; and
determine that an object is pinched by the opening and closing body based on the position of the opening and closing body and the load,
wherein the processing circuitry is configured to calculate the position of the opening and closing body based on a current value of the current measured in response to the detection of the ripple of the current.

2. The opening and closing control device according to claim 1, wherein the processing circuitry is configured to calculate the load based on the current value of the current measured at a time of the detection of the ripple.

3. The opening and closing control device according to claim 1, wherein the processing circuitry is configured to calculate the load based on a maximum or minimum current value of the current measured during a period from a time when the ripple of the current is detected to a time the next ripple of the current is detected.

4. The opening and closing control device according to claim 1, wherein the processing circuitry is configured to calculate the load based on an average of current value of the current measured during a period from a time the ripple of the current is detected to a time the next ripple of the current is detected.

5. The opening and closing control device according to claim 1, wherein the processing circuitry is configured to calculate the load based on a weighted moving average of current values of the current measured during a fixed duration from a time the ripple is detected.

6. The opening and closing control device according to claim 5, having the processing circuitry being further configured to measure a voltage supplied to the motor,
wherein the processing circuitry is configured to configure weightings such that:
when the voltage measured by the processing circuitry is equal to or greater than a threshold, a weight of a latest current value of the current measured by the processing circuitry in the weighted moving average is increased; and
when the voltage measured by the processing circuitry is less than the threshold, the weight of the latest current value of the current measured by the processing circuitry in the weighted moving average is decreased compared to when the voltage is equal to or greater than the threshold.

7. The opening and closing control device according to claim 6, wherein the processing circuitry calculates the weighted moving average of the current according to a following formula 1 based on the measured current value of the current,
$$Inew = \frac{( M - 1 ) \times Iold + Imeasure}{M} \times 2 - \frac{( 2 \times M - 1 ) \times Iold + Imeasure}{2 \times M} \qquad ( 1 )$$
wherein, Inew is a calculated value of the current value by the weighted moving average, and M is the weight, which is M1 when the voltage measured by the processing circuitry is equal to or greater than the threshold, and is M2 when the voltage measured by the processing circuitry is less than the threshold, where M1<M2 is satisfied, Iold is a calculated value of the current value by a previous weighted moving average, and Imeasure is the latest current value of the current measured by the processing circuitry.

8. The opening and closing control device according to claim 1, wherein the processing circuitry comprises:
a bandpass filter configured to pass a frequency component of the ripple of the current; and
a comparator configured to compare a reference potential with a signal passed through the bandpass filter.

9. The opening and closing control device according to claim 8, wherein the comparator is configured to output a pulse signal when the signal passed through the bandpass filter is larger than the reference potential.

10. The opening and closing control device according to claim 9, wherein the processing circuitry is configured such that each time the ripple of the current is detected, the current value of the current is measured, and the load is calculated.

11. The opening and closing control device according to claim 10, wherein the processing circuitry is configured to:
calculate a weighted average result of the calculated load as a reference value; and
set a pinch threshold to determine a permissible range of an excess amount of the load with respect to the reference value,
wherein the processing circuitry is configured to determine that an object is pinched by the opening and closing body when the excess amount of the load with respect to the reference value is larger than the pinch threshold.

12. The opening and closing control device according to claim 11, wherein the processing circuitry is configured to reversely rotate the motor when the pinch is detected.
